(19) United States
(12) Patent Application Publication
(10) Pub. No.: US 2025/0018530 A1
(43) Pub. Date: Jan. 16, 2025

(54) POWER TOOL WITH A SPECIFIC OUTPUT CURRENT

(71) Applicant: Hilti Aktiengesellschaft, Schaan (LI)

(72) Inventors: Ralf GREITMANN, Kaufering (DE); Ralf MEIXNER, Germaringen (DE); Stefan MAYER, Fensterbach (DE); John Van TAACK-TRAKRANEN, Muenchen (DE); Mathias FRENZEL, Unterdießen (DE); Markus HOLUBARSCH, Landsberg am Lech (DE); Klaus HAUSER, Schwabmünchen (DE)

(21) Appl. No.: 18/714,623

(22) PCT Filed: Nov. 11, 2022
(86) PCT No.: PCT/EP2022/081606

§ 371 Date: May 30, 2024

(30) Foreign Application Priority Data
Dec. 1, 2021 (EP) 21211569.5

(51) Int. Cl. B24B 47/12; B24B 27/08

(52) U.S. Cl. CPC B24B 47/12; B24B 27/08

(57) ABSTRACT

A power tool having a motor and an energy supply device, wherein an output current from the energy supply device to the power tool is greater than or equal to 70 amperes. The power-to-weight ratio of the power tool is in a range of greater than or equal to 0.30 kW/kg, for example. In addition, a power-to-weight ratio L of the power tool can preferably be in a range of greater than or equal to 0.30 kW/kg. In addition, a contact system for transmitting electrical energy from the energy supply device to the power tool is disclosed, wherein the contact system has at least one first contact and at least one second contact, wherein a contact area between the two contacts has a size of greater than or equal to 20 mm².

The present invention relates to a power tool having a motor and an energy supply device.

### BACKGROUND OF THE INVENTION

Large cut-off grinders, which can be used to machine or cut a substrate, are known in the field of power tools. Such cut-off grinders usually have a gasoline engine or an internal combustion engine in order to generate the power required to carry out the work. However, such gasoline-powered cut-off grinders or cutting devices are increasingly undesirable for ecological reasons, on the one hand because of the energy consumption and on the other hand because of the possible health impairments for the user, for example due to exhaust gases and the pollutants contained therein.

In order to remedy this, it has been proposed to tackle the energy supply for such cut-off grinders differently, for example by means of electrical energy supply devices such as batteries or replaceable rechargeable batteries.

### SUMMARY OF THE INVENTION

A disadvantage of such battery-operated cut-off grinders can be an excessively low performance of the device, which can lead to the cutting-off or cutting work to be carried out with the power tool not being able to be carried out or not being able to be carried out satisfactorily.

It is an object of the invention to overcome the above-described shortcomings and disadvantages of the prior art and to provide a battery-operated or rechargeable battery-operated power tool which makes it possible to carry out cutting-off or cutting work which requires a high power.

The invention provides a power tool having a motor and an energy supply device, wherein an output current from the energy supply device to the power tool is greater than or equal to 70 amperes. In a particularly preferred configuration of the invention, the output current from the energy supply device to the power tool can be, for example, 73 amperes or more than 80 amperes. The high output currents can be provided in particular by using particularly powerful rechargeable batteries and/or batteries in the power tool as the energy supply device. For example, two rechargeable batteries can form an energy supply device for the power tool, wherein this energy supply device supplies the power tool with electrical energy and makes it possible to output the surprisingly high currents. It is preferred in the context of the invention for the rechargeable batteries to each have a positive contact and a negative contact. However, it can also be preferred in the context of the invention for the rechargeable batteries to have more than one positive contact and more than one negative contact. For example, the rechargeable batteries of the power tool can have two positive contacts and two negative contacts. Of course, more than two positive poles and/or negative poles in the region of the rechargeable batteries of the power tool are also conceivable. In the context of the invention, it can be particularly preferred for two or more power consumption elements to be used.

It is preferred in the context of the invention for the power tool to have a contact system for transmitting electrical energy between the power tool and the energy supply device, wherein the contact system has at least one first contact and at least one second contact, wherein the contacts have a contact area with a size of greater than or equal to 20 mm². The contact area represents in particular a contact cross-sectional area.

The poles or the contacts of the rechargeable batteries can form a contact system together with the corresponding poles or contacts of the power tool. The contact system comprises one or more rechargeable battery-side contacts, which are preferably referred to as “first contacts” in the context of the invention, as well as one or more device-side contacts, which are preferably part of the power tool and interact with the rechargeable battery-side contacts in order to form a current-carrying connection between the rechargeable batteries and the power tool. The rechargeable battery-side contacts or poles can preferably also be referred to as a group of first contacts in the context of the invention. In the context of the invention, the device-side contacts or poles are preferably referred to as second contacts or as a group of second contacts. The contact system preferably forms an interface between the energy supply device and the power tool, by means of which the electrical energy can be conducted or carried from the rechargeable batteries to the power tool. The contact system comprising the first and second contacts is characterized by a current transmission cross section, wherein the current transmission cross section is formed by an area which is 20 mm² or larger. It is preferred in the context of the invention for the current transmission cross section to be defined by a maximum area cross section that is formed by at least one first contact with at least one second contact. In other words, the current transmission cross section is the area through which electrical energy can pass from the first contacts to the second contacts. In the context of the invention, it is preferred for the electrical energy to be conducted from the at least one rechargeable battery to the power tool through the first and second contacts that are touching or in contact, wherein the contact area of the first and second contacts is preferably greater than or equal to 20 mm². The contact area is preferably defined by the region or that area in which the first and second contacts touch. The contact system makes it possible to continuously transmit current of more than 70 amperes, preferably more than 73 amperes, and most preferably of more than 80 amperes, between rechargeable batteries and the power tool. In the context of the invention, this preferably means that the currents mentioned are a continuous current which is not only output for a short time or as a peak, but preferably over a longer period of time.

The contacts can be in the form of female and male plug contacts. It is preferred in the context of the invention for the first contacts to be in the form of female plug contacts and for the second contacts to be in the form of male plug contacts. However, it can also be preferred for the first contacts to be in the form of male plug contacts and for the second contacts to be in the form of female plug contacts. It is most preferred for the first contacts to be present on the rechargeable battery and to be female, while the second contacts are arranged on the power tool and are male.

Preferably, the connection between the first and the second contacts is based on touching between the contacts that exists in the region of a contact area. The size of this contact area is preferably in a range of greater than or equal to 20 mm². In an exemplary embodiment of the invention, the contact area can have a size of 24.4 mm², for example.

Of course, instead of the groups of first and second contacts, the contact system may comprise only one first contact and one second contact. Then, for example, a first contact, which is preferably female, is present on a rechargeable battery of the energy supply device, while a second contact, which is preferably male, is arranged on the power tool.

A particular advantage of the invention is that it is possible to provide a power tool whose energy supply device can output a continuous current of greater than or equal to 70 amperes in the direction of the power tool. This high output current is preferably achieved by means of a contact system having rechargeable battery-side contacts and device-side contacts which together have a contact area of greater than or equal to 20 mm². The contacts can in particular be two positive contacts and two negative contacts. It can also be preferred in the context of the invention for the contact system to be formed by corresponding male and female plug contacts, the contact area of which has a size of greater than or equal to 20 mm². It is preferred in the context of the invention for the contact area between a first and a second contact to have a size of greater than or equal to 20 mm².

It was completely surprising that the invention can be used to provide a power tool with an output current of 70 amperes or more. In the context of the invention, it is preferred for the current to flow between the energy supply device and the power tool via one positive or negative pole. However, it can also be preferred in the context of the invention for the current to flow between the energy supply device and the power tool via two positive or negative poles. The output current is preferably output from the energy supply device to the power tool and is received by the power tool. In the context of the invention, the output current can also be referred to as the intake current or as the supply current. In this respect, the invention relates in particular to a battery-operated or rechargeable battery-operated power tool with particularly high intake currents.

It is preferred in the context of the invention for a power-to-weight ratio L of the power tool to be able to be defined by a quotient of an output power P of the motor and a mass M1 of the power tool, where L=P/M1. The power tool can have a power-to-weight ratio L in a range of greater than or equal to 0.30 kW/kg. It is a surprising advantage of the invention that it is possible to provide a power tool which has a power-to-weight ratio L of greater than or equal to 0.30 kW/kg. Previously, such power-to-weight ratios for power tools had not been considered feasible by experts, particularly when the power tool is a battery-operated or rechargeable battery-operated power tool. The power tool advantageously combines a high output power P of the motor of the power tool with a surprisingly low mass M1 of the power tool, thus obtaining a quotient of these variables in a range of greater than or equal to 0.30 kW/kg. The invention thus turns away precisely from the prior art which had not considered such high power-to-weight ratios to be possible. In a particularly preferred configuration of the invention, the power-to-weight ratio L as the quotient of output power and mass of the power tool can be 0.333 kW/kg, for example.

The power tool has an energy supply device, wherein the energy supply device of the power tool comprises one rechargeable battery, two rechargeable batteries or more rechargeable batteries. In the context of the invention, it is preferred for the mass M1 to describe the total weight of the power tool. The total weight of the power tool corresponds to the weight of the power tool in an operational configuration, i.e. in a configuration in which work can be carried out with the power tool. In this operational configuration, the power tool comprises, in particular, the energy supply device and a tool, which is described further below. In other words, the mass M1 of the power tool represents the total weight of the power tool and its components, as required for the operation of the power tool. The mass M1 thus includes in particular the individual masses of the actual power tool, its tool and the energy supply device.

It is preferred in the context of the invention for a mass M2 of the energy supply device to be in a range from 1 to 2 kg, preferably in a range from 1.2 to 1.5 kg and most preferably approximately 1.25 kg. The mass M2 or the weight of the batteries and/or rechargeable batteries, which preferably form the energy supply device, can for example be in a range from 1 to 2 kg, preferably in a range from 1.2 to 1.5 kg and most preferably approximately 1.25 kg. In a particularly preferred configuration of the invention, the weight M2 of the energy supply device is 1.26 kg. The term “mass of the energy supply device” is used here as the mass or weight of the cells of the energy supply device. In other words, the mass M2 of the energy supply device corresponds to the total weight of the cells of the rechargeable batteries of the energy supply device. The weight M2 of the energy supply device can result, for example, as a product of the masses of the individual cells and the number of cells in the energy supply device.

In a preferred configuration of the invention, a ratio K of the mass M2 of the energy supply device of the power tool to the output power P of the motor of the power tool is in a range of less than or equal to 0.45 kg/kW, where K=M2/P. This ratio also expresses the surprisingly high output power of the power tool or its motor in relation to a mass feature of the power tool. A particularly high power density in relation to the weight of the energy supply device can therefore be provided with the power tool. In the context of the invention, this preferably means that, considering the size and weight of the energy supply device, it is possible to provide a particularly powerful power tool which can be advantageously used to also carry out difficult and power-intensive cutting-off and cutting work. The power tool provided with the invention is surprisingly light and the user can work with the power tool for a particularly long period of use without physical impairments.

It is preferred in the context of the invention for a volume of the energy supply device of the power tool to be less than or equal to 0.5 l. In a particularly preferred configuration of the invention, the volume of the energy supply device can be 0.47 l. This makes it possible to provide a particularly compact and handy power tool, thus further facilitating work with the power tool.

Preferably, a rechargeable battery of the energy supply device has a rated voltage in a range from 20 to 25 volts (V), preferably in a range from 21 to 23 V, and most preferably in a range from 21.5 to 22 V. The energy supply device of the power tool can, for example, comprise one or two rechargeable batteries, wherein more than two rechargeable batteries are also conceivable. It is preferred in the context of the invention for each rechargeable battery of the energy supply device to have a rated voltage in a preferred range from 21.5 to 22 V. If the energy supply device of the power tool has two rechargeable batteries, for example, a total voltage of the energy supply device is in a range from 43 to 44 V, wherein this value preferably represents the sum of the individual voltages of the batteries and/or rechargeable batteries that form the energy supply unit.

In a preferred configuration of the invention, the motor of the power tool is a brushless motor. In particular, the motor of the power tool can be a brushless electric motor. The motor preferably has an overall length of greater than or equal to 30 mm. For example, a stator lamination of the motor can have a length of 30 mm or more. In addition, the motor may have an outside diameter in a range of greater than or equal to 75 mm.

In the context of the invention, it is preferred for an output power P of the motor of the power tool to be in a range from 2 to 4 KW, preferably in a range from 2.5 to 3.3 kW and most preferably approximately 2.8 kW. The surprisingly high output power P of the motor of the power tool is preferably attributable to the motor parameters mentioned. In order to achieve the high output power values, use is advantageously made of a brushless motor which is particularly compact and has a high utilization of space or volume.

In a preferred configuration of the invention, an efficiency of the power tool is in a range of greater than or equal to 0.70, preferably in a range of greater than or equal to 0.75. In the context of the invention, the term “efficiency of the power tool” preferably describes the efficiency of the drive system of the power tool, wherein the drive system of the power tool preferably comprises electronics and the motor of the power tool. The efficiency of the drive system of the power tool is therefore preferably in a range of greater than or equal to 0.8, preferably in a range of greater than or equal to 0.85. In the context of the invention, the efficiency preferably represents the quotient of the input power of the motor of the power tool and the output power of the motor of the power tool.

The input power of the motor of the power tool can be, for example, in a range from 2.5 to 4 KW, preferably in a range from 3 to 3.5 kW and most preferably approximately 3.2 kW.

It is preferred in the context of the invention for the power tool to be an angle grinder, a cut-off grinder or a cutting device. In particular, the invention represents a hand-held electric power tool that can preferably be battery-operated or rechargeable battery-operated. The output current from the energy supply device to the power tool is greater than or equal to 70 A and can be 73 A, for example, with the result that the invention can be used to provide a particularly powerful battery-operated or rechargeable battery-operated cut-off grinder with a surprisingly high supply current. The output current from the energy supply device in the direction of the power tool preferably also represents the intake current of the power tool from the direction of the energy supply device.

The power tool has in particular a disk-shaped tool, wherein a diameter of the disk-shaped tool can be in a range from 250 to 450 mm, preferably in a range from 270 to 400 mm, more preferably in a range from 290 to 350 mm and most preferably approximately 300 mm. In the context of the invention, it is particularly preferred for the diameter of the disk-shaped tool to be greater than or equal to 300 mm. This way cutting-off or cutting work can be carried out particularly effectively and easily.

In a preferred configuration of the invention, a mass M1 of the power tool is in a range from 6 to 12 kg, preferably in a range from 8 to 10 kg, more preferably in a range from 8.3 to 9 kg and most preferably in a range of less than or equal to 8.6 kg. In particular, a total weight of the power tool of approximately 8.6 kg or less represents a very low total weight for cut-off grinders, especially when the weight of the energy supply device and the tool is included. It is preferred in the context of the invention for the surprisingly low weight of the power tool to be achieved by using materials such as aluminum and/or high-strength plastic. In particular, the power tool comprises a lightweight frame construction. A high level of functional integration in the main components of the power tool, such as the motor housing, reduces the number of individual parts required and thus leads to a further reduction in weight.

In the context of the invention, it is preferred for an intake power of the power tool to be in a range from 2.5 to 4 KW, preferably in a range from 3 to 3.5 KW and most preferably approximately 3.2 kW.

The numerical ranges disclosed with regard to the invention should each be understood in such a way that all integer, rational and irrational intermediate values are also included and are to be regarded as disclosed.

### BRIEF DESCRIPTION OF THE DRAWINGS

Further advantages of the invention will become apparent from the following description of the figures. The figure, the description and the claims contain numerous features in combination. A person skilled in the art will expediently also consider the features individually and combine them to form useful further combinations.

Identical and similar components are denoted by the same reference signs in the figure, in which:

FIG. 1 shows a view of a preferred configuration of the power tool.

FIG. 2 shows a view of a preferred configuration of the contact system for transmitting electrical energy from the energy supply device to the power tool.

### DETAILED DESCRIPTION

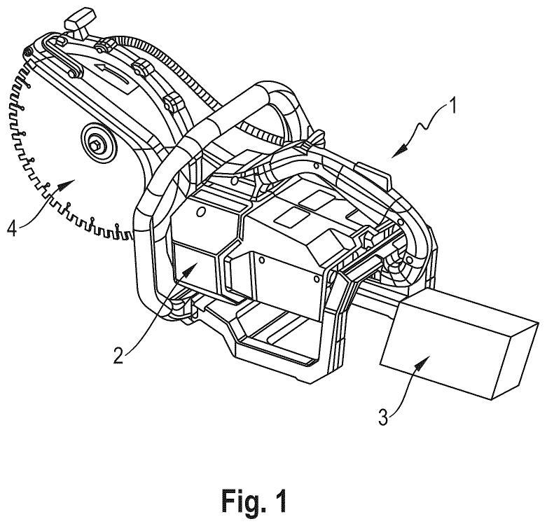

FIG. 1 shows a preferred configuration of the power tool 1. In particular, FIG. 1 shows a cut-off grinder 1 which comprises a motor 2. The motor 2 can be arranged between a cutting arm and an energy supply device 3. In particular, it can be a brushless electric motor, wherein the motor 2 has an outside diameter of greater than or equal to 75 mm, for example. The energy supply device 3 can comprise one, two or more rechargeable batteries, wherein the rechargeable battery or rechargeable batteries can be inserted into a receiving or battery compartment on a rear side of the power tool 1, for example. A total weight M2 of the energy supply device 3 can be 1.26 kg, for example. In the context of the invention, it is preferred for the energy supply device 3 having the rechargeable batteries to be present in a rear region of the power tool 1, in particular in spatial proximity to an underside of the main body of the power tool 1. A rechargeable battery 100 (shown solely schematically) of the energy supply device 3 of the power tool 1 preferably has two positive contacts and two negative contacts 101 (also shown solely schematically). This can advantageously make it possible to provide the particularly high output currents. If the energy supply device 3 has more than one rechargeable battery, it is preferred in the context of the invention for all rechargeable batteries of the power tool 1 to have two positive contacts and two negative contacts. However, it can also be preferred for only a subset of the rechargeable batteries to have two positive contacts and two negative contacts for transmitting the electrical energy. The positive contacts and negative contacts preferably form the interface between the energy supply device 3 and the power tool 1, wherein the task of the interface is to transmit the electrical energy—for example stored in the rechargeable batteries—from the energy supply device 3 to the power tool 1.

A tool 4 can be provided on the cutting arm of the power tool 1 and can preferably be disk-shaped. It can preferably be a cut-off or cutting blade. In the context of the invention, it is preferred for the tool 4 to have a diameter of 300 mm.

The motor 2 of the power tool 1 is preferably designed in such a way that the motor 2 can provide an input power of, for example, 3.3 KW and an output power P of approximately 2.8 KW. The power-to-weight ratio L of the power tool 1 illustrated in FIG. 1 is in a range of greater than or equal to 0.30 kW/kg, wherein the power-to-weight ratio L is formed by a quotient of the output power P of the motor 2 and the mass M1 of the power tool 1. In addition, a ratio of the mass of the energy supply device 3 of the power tool 1 to the output power of the motor 2 of the power tool 1 can be in a range of less than or equal to 0.45 kg/kW.

The invention provides for an output current from the energy supply device 3 in the direction of the power tool 1 to be greater than or equal to 70 A. For example, this intake current of the power tool 1 or its supply current can be 73 amperes.

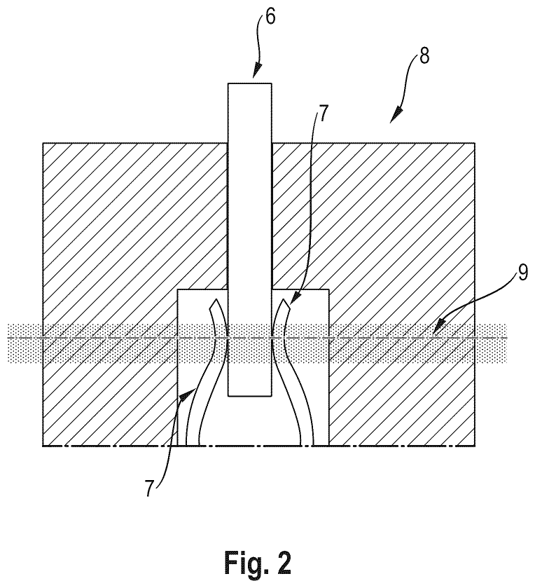

FIG. 2 shows a preferred embodiment of the contact system 8 which can be used to transmit electrical energy from the energy supply device 3 to the power tool 1. The contact system 8 has two different groups of contacts which can be in the form of, for example, positive and negative poles or female contacts 7 and male contacts 6. The contacts 6, 7 have a contact region 9 or a contact cross-sectional area 9 with an area of greater than or equal to 20 mm². For example, the male contacts 6 represent the group of second contacts, wherein these second contacts 6 are preferably present on the power tool 1 and are male. Analogously, the female contacts 7 can represent the group of first contacts, wherein these first contacts 7 are preferably present on the energy supply device 3 and are female. The first or the female contacts 7 are preferably present on the at least one rechargeable battery of the energy supply device 3 of the power tool 1.

### LIST OF REFERENCE SIGNS

1 Power tool
2 Motor
3 Energy supply device
4 Disk-shaped tool
5 Contact system
6 Male contact
7 Female contact
8 Contact system
9 Contact region, contact cross-sectional area

What is claimed is:

1-15: (canceled)

16: A power tool comprising:
a motor; and
an energy supply device, an output current from the energy supply device to the power tool being greater than or equal to 70 amperes.

17: The power tool as recited in claim 1 wherein the energy supply device includes at least one rechargeable battery.

18: The power tool as recited in claim 17 wherein the rechargeable battery of the energy supply device has a rated voltage in a range from 20 to 25 V.

19: The power tool as recited in claim 17 wherein the rechargeable battery of the energy supply device has a rated voltage in a range from 21 to 23 V.

20: The power tool as recited in claim 17 wherein the rechargeable battery of the energy supply device has a rated voltage in a range from 21.5 to 22 V.

21: The power tool as recited in claim 17 wherein the rechargeable battery of the power tool has two positive contacts and two negative contacts.

22: The power tool as recited in claim 16 further comprising a contact system for transmitting electrical energy between the power tool and the energy supply device, wherein the contact system has at least one first contact and at least one second contact, wherein the first and second contacts have a contact cross-sectional area with a size of greater than or equal to 20 mm².

23: The power tool as recited in claim 16 wherein a mass of the energy supply device is in a range from 1 to 2 kg.

24: The power tool as recited in claim 16 wherein a mass of the energy supply device is in a range from 1.2 to 1.5 kg.

25: The power tool as recited in claim 16 wherein a mass of the energy supply device is 1.25 kg.

26: The power tool as recited in claim 16 wherein a ratio of the mass of the energy supply device to the output power P of the motor of the power tool is in a range of less than or equal to 0.45 kg/kW.

27: The power tool as recited in claim 16 wherein a power-to-weight ratio of the power tool is in a range of greater than or equal to 0.30 kW/kg.

28: The power tool as recited in claim 16 wherein the power tool (1) has a disk-shaped tool.

29: The power tool as recited in claim 28 wherein a diameter of the disk-shaped tool is in a range from 250 to 450 mm.

30: The power tool as recited in claim 28 wherein a diameter of the disk-shaped tool is in a range from 270 to 400 mm.

31: The power tool as recited in claim 28 wherein a diameter of the disk-shaped tool is in a range from 290 to 350 mm.

32: The power tool as recited in claim 28 wherein a diameter of the disk-shaped tool is 300 mm.

33: The power tool as recited in claim 16 wherein a mass of the power tool is in a range from 6 to 12 kg.

34: The power tool as recited in claim 16 wherein a mass of the power tool is in a range from 8 to 10 kg.

35: The power tool as recited in claim 16 wherein a mass of the power tool is in a range from 8.3 to 9 kg.

36: The power tool as recited in claim 16 wherein a mass of the power tool is 8.6 kg.

37: The power tool as recited in claim 16 wherein an output power of the motor is in a range from 2 to 4 kW.

38: The power tool as recited in claim 16 wherein an output power of the motor is in a range from 2.5 to 3.3 kW.

39: The power tool as recited in claim 16 wherein an output power of the motor is 2.8 kW.

40: The power tool as recited in claim 16 wherein the motor has an outside diameter in a range of greater than or equal to 75 mm.

41: The power tool as recited in claim 16 wherein an efficiency of the power tool is in a range of greater than or equal to 0.70.

42: The power tool as recited in claim 16 wherein an efficiency of the power tool is in a range of greater than or equal to 0.75.

43: The power tool as recited in claim 16 wherein an intake power of the power tool is in a range from 2.5 to 4 kW.

44: The power tool as recited in claim 16 wherein an intake power of the power tool is in a range from 3 to 3.5 kW.

45: The power tool as recited in claim 16 wherein an intake power of the power tool is 3.2 kW.
